(19) United States
(12) Patent Application Publication
(10) Pub. No.: US 2004/0262880 A1
(43) Pub. Date: Dec. 30, 2004

(54) Kickstand receiving member and carrying case

(76) Inventor: Shawn C. McClure, New Boston, NH (US)

Correspondence Address: Bourque & Associates, P.A., Suite 303, 835 Hanover Street, Manchester, NH, 03104, US

(21) Appl. No.: 10/874,627

(22) Filed: Jun. 23, 2004

Related U.S. Application Data
(60) Provisional application No. 60/480,914, filed on Jun. 24, 2003.

(51) Int. Cl. B62H 1/00

(52) U.S. Cl. 280/293

(57) ABSTRACT

A kickstand receiving member having a cavity therein for receiving a first end of a kickstand. The kickstand receiving member precluding the kickstand from penetrating a supporting surface or ground, and the cavity for precluding the kickstand from sliding across and off of a top surface of the kickstand receiving member. A carrying case having a flap and main compartment is disclosed. The carrying case is used for carrying the kickstand receiving member when it is not in use.

### CROSS-REFERENCE TO RELATED APPLICATION

This application claims priority from U.S. Provisional Patent Application No. 60/480,914, entitled “Kickstand Receiving Member and Carrying Case,” which was filed on Jun. 24, 2003.

### TECHNICAL FIELD OF THE INVENTION

The present invention relates to accessories for motorcycles and bicycles and more particularly, to a kickstand receiving member having a cavity therein for supporting a motorcycle or bicycle in an upright or parked position.

### DESCRIPTION OF THE RELATED ART

A motorcycle or bicycle is generally parked or put in an upright position with a kickstand. However, there are problems associated with supporting a motorcycle or bicycle on a kickstand.

First, when the motorcycle or bicycle is parked in the upright position on the kickstand, the kickstand has been known to penetrate a supporting surface or ground on which the kickstand is supporting the motorcycle or bicycle. This problem is magnified when the motorcycle or bicycle is parked on a soft surface such as dirt, grass, sand, tar, or other similar soft surface. The kickstand has been known to penetrate the surface or ground on which it is positioned to support the motorcycle or bicycle. When the kickstand penetrates the surface or ground, the motorcycle or bicycle falls over potentially causing damage to the motorcycle or bicycle and potentially injuring someone. The kickstand penetrates the surface or ground because of the weight of the motorcycle or bicycle, softness of the surface or ground, and/or limited surface area of the kickstand in contact with the surface or ground. There is therefore a need for a device for preventing the kickstand of a motorcycle or bicycle from penetrating the surface or ground that the motorcycle or bicycle is parked on to prevent the motorcycle or bicycle from falling over.

Second, it is known in the prior art that when an external force (e.g., wind, etc.) is applied to a motorcycle or bicycle in a parked position, the kickstand tends to move thereby causing the motorcycle or bicycle to fall over. There is therefore also a need for a device that will prevent the kickstand from moving when an external force is applied to the motorcycle or bicycle in the parked position.

It is also known in the prior art to provide a kickstand support pad for maintaining a two-wheeled vehicle in an upright position. One of the problems with this device is that a kickstand mounted thereon tends to slide off of a top surface of the kickstand support pad and into the soft surface or ground thereby causing the two-wheeled vehicle to fall over. There is a need for a device that will preclude the kickstand from sliding off of the top surface of the kickstand support pad.

### SUMMARY OF THE INVENTION

The invention includes a kickstand receiving member having a cavity therein for receiving a first end of a kickstand. The kickstand receiving member precludes the kickstand from penetrating a supporting surface or ground, while the cavity precludes the kickstand from sliding along and off of a top surface of the kickstand receiving member.

A kickstand receiving member has a recessed or cavity section in a first surface of the kickstand receiving member. The recessed section receives a first end of a kickstand. In an alternative embodiment, a protruding section surrounds the recessed section. The kickstand receiving member precludes the kickstand from penetrating a supporting surface or ground, while the recessed or cavity section precludes the kickstand from sliding along and off of a top surface of the kickstand receiving member. In an alternative embodiment, the protruding section also precludes the kickstand from sliding along and off of a top surface of the kickstand receiving member.

In an alternative embodiment, the kickstand receiving member may have protruding section on the top surface and no cavity or recess. In this embodiment, the kickstand receiving member precludes the kickstand from penetrating the supporting surface or ground, while the protruding section precludes the kickstand from sliding along and off of a top surface of the kickstand receiving member.

A carrying case having a flap and main compartment is also provided for carrying the kickstand receiving member when it is not in use.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken with the drawings wherein:

FIG. 1 is a perspective view of a kickstand receiving member having a cavity showing a kickstand positioned in the cavity according to the present invention;

FIG. 2 is an end view of the kickstand receiving member as shown in FIG. 1;

FIG. 3 is a top view of an alternative embodiment of the kickstand receiving member having a protruding section;

FIG. 4 is a front view of a carrying case for the kickstand receiving member in an open position; and

FIG. 5 is a side view of the carrying case in a closed position having the kickstand receiving member therein.

### DETAILED DESCRIPTION

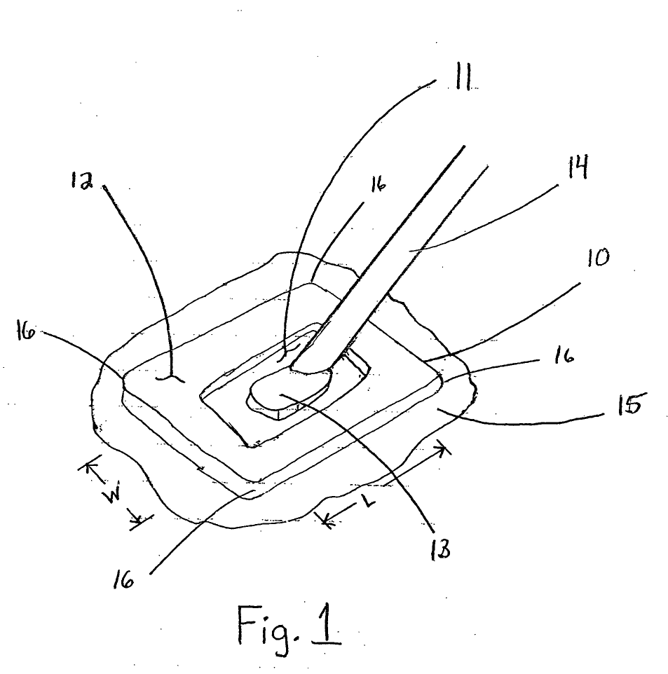

When a motorcycle or bicycle is parked or in an upright position, the motorcycle or bicycle typically contacts a support surface or ground 15, FIG. 1, in three places. The points of contact are the front wheel, back wheel, and a first end 13 of a kickstand 14. The first end 13 of the kickstand 14 may penetrate the support surface or ground 15 thereby causing the motorcycle or bicycle to topple or fall over. Further, if the kickstand 14 is placed on a support pad or other device, the first end 13 of the kickstand 14 may slide across and off of the support pad thereby causing the motorcycle or bicycle to topple or fall over.

A kickstand receiving member 10, FIG. 1, having a cavity 11 therein according to the present invention is used to prevent the motorcycle or bicycle from falling over as previously described. The kickstand receiving member 10 has a length and width, defining a surface area for dissipating the weight of the motorcycle or bicycle resting on it thereby preventing the kickstand 14 from penetrating the support surface or ground 15. A typical representative length and width are 3 ½ and 1 ½ inches, respectively. Further, the cavity 11 of the kickstand receiving member 10 precludes the first end 13 of the kickstand 14 from sliding off of the kickstand receiving member 10.

The kickstand receiving member 10 is preferably made from a lightweight material. In the preferred embodiment, the kickstand receiving member 10 is made from high strength 6061-T6 aircraft aluminum; however, the kickstand receiving member 10 can be made from other materials that are capable of supporting the weight of a motorcycle or bicycle.

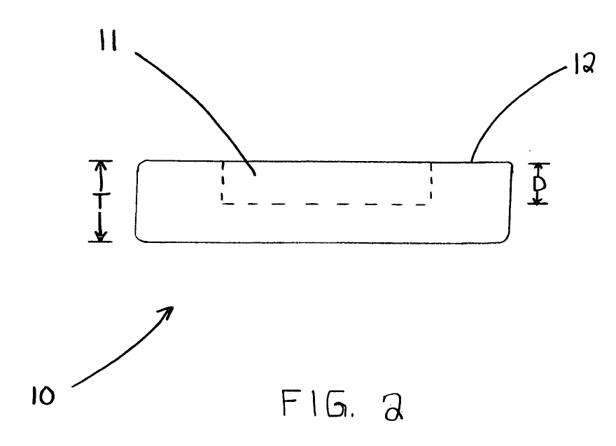

The cavity 11 is recessed in a top surface 12 of the kickstand receiving member 10. The cavity 11 extends downward through the top surface 12 and through approximately one-half of a thickness “T”, FIG. 2, of the kickstand receiving member 10. The cavity 11 has a length “L” and width “W”. The length “L” and the width “W” of the cavity 11 are larger than a length and a width of the first end 13 of the kickstand 14, respectively, as shown in FIG. 1. The first end 13 of the kickstand 14 rests in the cavity 11 of the kickstand receiving member 10.

The first end 13 of the kickstand 14 is confined to the area of the cavity 11 when the motorcycle or bicycle is placed in the park or upright position. The cavity 11 precludes the first end 13 of the kickstand 14 from moving or sliding off of the kickstand receiving member 10, thereby preventing the motorcycle or bicycle from toppling or falling over when in the parked position.

In an alternative embodiment, the cavity 11 has a large area and is between four and five square inches to accommodate most kickstands. The larger cavity 11 allows for efficient alignment of the first end 13 of the kickstand 14 into the cavity 11 of the kickstand receiving member 10.

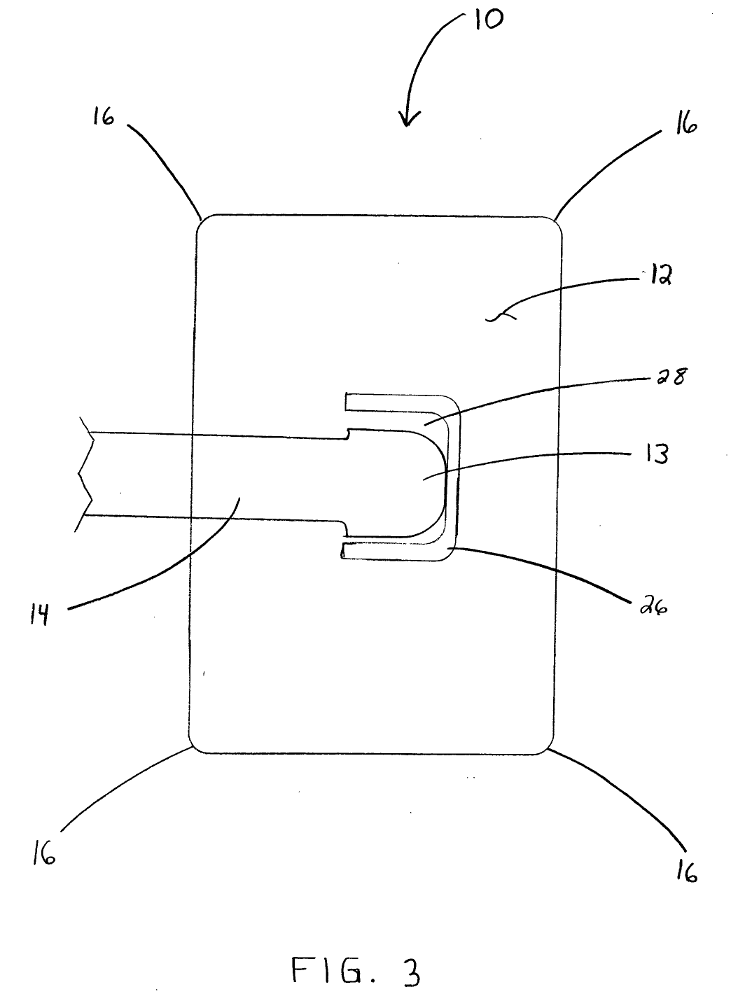

In an alternative embodiment, a protruding section 26, FIG. 3, extends from the top surface 12 of the kickstand receiving member 10. The protruding section 26 may be a three-sided weld created on the top surface 12. The protruding section 26 may be integral to the kickstand receiving member 10. For example, the kickstand receiving member 10 may be machined from raw stock with the protruding section 26 extending from the top surface 12 of the kickstand receiving member 10 on three or four sides. In an alternative embodiment, the protruding section 26 may be used in conjunction with the cavity 11.

The protruding section 26 may be “U” shaped, “V” shaped, or “O” shaped for receiving the first end 13 of the kickstand 14. In other embodiments, the protruding section 26 may have the shape of the first end 13 of the kickstand 14. The protruding section 26 forms a pocket 28 for receiving the first end 13 of the kickstand 14 precluding the first end 13 of the kickstand 14 from moving or sliding off of the kickstand receiving member 10 thereby preventing the motorcycle or bicycle from toppling or falling over when in the parked position. The protruding section 26 may partially or fully surround the first end of the kickstand 14.

The kickstand receiving member 10 can be made in various shapes and designs. For example, it may be desirable to have the kickstand receiving member 10 in the shape of the motorcycle manufacturer's logo, trademark or in the shape of a foot. In its simplest design, the kickstand receiving member 10 is rectangular having rounded corners 16. The top surface 12 of the kickstand receiving member 10 can be personalized, painted, etc.

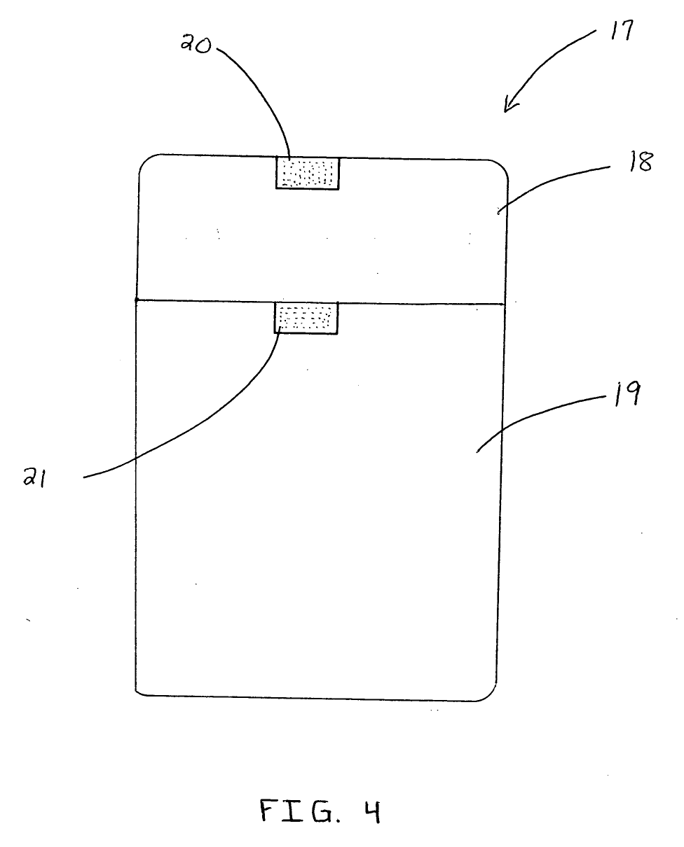

A carrying case 17 for holding the kickstand receiving member 10 is shown in FIG. 4 in a open position. The carrying case 17 is preferably made of leather, faux leather, cloth, nylon, or other similar materials. The carrying case 17 has a flap 18 and a main compartment 19. After placing the kickstand receiving member 10 into the carrying case 17, the flap 18 is fastened to the main compartment 19. In one embodiment, fasteners 20, 21, such as hook and loop fasteners, are used to fasten the flap 18 to the main compartment 19, respectively. In other embodiments, other devices, or other fasteners, such as a button/slit, snap/hook, zipper/teeth, etc. are used to fasten the flap 18 to the main compartment 19.

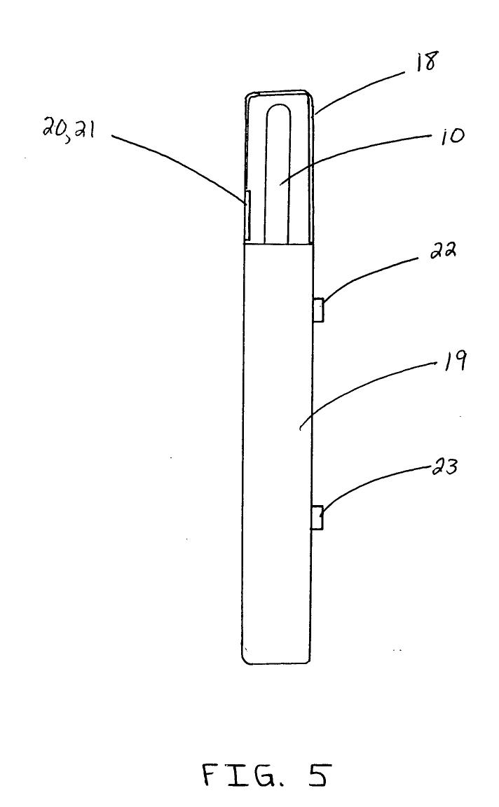

When the kickstand receiving member 10 is not in use, it can be stored in the carrying case 17, best shown in FIG. 5. The kickstand receiving member 10 is placed in the main compartment 19. Thereafter, the flap 18 is fastened to the main compartment 19.

The carrying case 17 has attachment loops 22, 23. The attachment loops 22, 23 are used to attach the carrying case 17 to the motorcycle, bicycle, or clothing of a person. In one embodiment, the attachment loops 22, 23 have a first end and a second end. The first end has a first side attached to the carrying case and a second side attached to one portion of a hook/loop fastener system. The second end has a first side attached to another portion of a hook/loop fastener system. The hook/loop fasteners allow attachment loops 22, 23 to be readily removed and attached.

The present invention is not intended to be limited to a device or method which must satisfy one or more of any stated or implied object or feature of the invention and is not be limited to the preferred, exemplary, or primary embodiment(s) described herein. Modification and substitutions by one of ordinary skill in the art are considered to be within the scope of the present invention.

What is claimed is:

1. A kickstand receiving member for receiving a first end of a kickstand, the kickstand receiving member comprising:
a first surface; and
a cavity disposed in said first surface and having an area less than an area of said first surface, and having a depth less than a thickness of said kickstand receiving member, said cavity for receiving the first end of the kickstand.

2. The kickstand receiving member according to claim 1, wherein the cavity is through approximately one-half the thickness of the kickstand receiving member.

3. The kickstand receiving member according to claim 1, wherein the kickstand receiving member is high strength 6061-T6 aluminum.

4. The kickstand receiving member according to claim 1, wherein the cavity on the top surface is between four and five square inches.

5. The kickstand receiving member according to claim 1, wherein the kickstand receiving member has a shape, and the shape is either a logo or trademark.

6. The kickstand receiving member according to claim 1, wherein the kickstand receiving member has a shape, and the shape is a profile of a person's foot.

7. The kickstand receiving member according to claim 1, wherein the kickstand receiving member has rounded corners.

8. The kickstand receiving member according to claim 1, wherein a force applied by the first end of the kickstand to the kickstand receiving member is dissipated throughout the kickstand receiving member.

9. The kickstand receiving member according to claim 1, further including a carrying case, for storing the kickstand receiving member when it is not being used.

10. A kickstand plate for a first end of a kickstand, comprising:
a body having a cavity disposed within the body; and
wherein the cavity receives the first end of the kickstand.

11. The kickstand plate according to claim 10, wherein the body has a thickness, and the cavity is through approximately one-half the thickness of the body.

12. The kickstand plate according to claim 10, wherein the kickstand plate is high strength 6061-T6 aluminum.

13. The kickstand plate according to claim 10, further including a carrying case, for storing the kickstand plate when it is not being used.

14. The kickstand plate according to claim 13, wherein the carrying case is made from either leather, faux leather, cloth, or nylon.

15. The kickstand plate according to claim 13, wherein the carrying case has a main compartment and a flap, and wherein the kickstand plate is placed into the carrying case and the main compartment and the flap are fastened together via a fastener.

16. The kickstand plate according to claim 13, wherein the carrying case has attachment members, for strapping the carrying case either a motorcycle, bicycle, or a person's clothing.

17. A kickstand receiving member for receiving a first end of a kickstand, the kickstand receiving member comprising:
a first surface having a protruding section, wherein the protruding section extends from the first surface; and
wherein the protruding section forms a pocket, for receiving the first end of the kickstand.

18. The kickstand receiving member according to claim 17, wherein the pocket partially surrounds the first end of the kickstand.

19. The kickstand receiving member according to claim 17, wherein the pocket surrounds the first end of the kickstand.

20. The kickstand receiving member according to claim 17, further including a carrying case, for storing the kickstand receiving member when it is not being used.
